(19) United States
(12) Patent Application Publication
(10) Pub. No.: US 2011/0168674 A1
(43) Pub. Date: Jul. 14, 2011

(54) PLASMA PROCESSING METHOD AND APPARATUS

(75) Inventors: Satoshi Mayumi, Kyoto-shi (JP); Shunsuke Kunugi, Kyoto-shi (JP); Takashi Satoh, Kyoto-shi (JP); Takashi Umeoka, Tsukuba-shi (JP)

(73) Assignee: SEKISUI CHEMICAL CO., LTD., Osaka-shi, Osaka (JP)

(21) Appl. No.: 13/061,749

(22) PCT Filed: Sep. 7, 2009
(86) PCT No.: PCT/JP2009/004403

§ 371 Date: Mar. 31, 2011

(30) Foreign Application Priority Data
Sep. 10, 2008 (JP) 2008-232121

(51) Int. Cl. C23F 1/00; C23F 1/08; B01D 53/00

(52) U.S. Cl. 216/67; 156/345.26

(57) ABSTRACT

In atmospheric-pressure plasma processing, fluctuation of a recovery rate or a recovery concentration of a fluorine raw material is restrained to secure stability of processing.

Exhaust gas led out from an atmospheric-pressure plasma processing part 2 to an exhaust line 30 is separated by a separation membrane 41 of a separation part 4 into collected gas for a recovered line 50 and release gas for a release line 60. The collected gas is utilized as at least a part of processing gas. At the time of the separation, physical quantity (preferably pressure) of at least two gases of the collected gas, the release gas and the exhaust gas related to the separation are regulated according to flow rate of the processing gas so that either one or both of a recovery rate or a recovery concentration of a fluorine raw material are as desired.

### TECHNICAL FIELD

The present invention relates to a method and an apparatus for surface processing a substrate by plasmatizing processing gas including a fluorine raw material such as CF₄ or SF₆ under near atmospheric pressure and bringing the processing gas into contact with the substrate, and particularly relates to a plasma processing method and apparatus including steps or circuits for collecting and recycling the fluorine raw material from exhaust gas after the processing.

### BACKGROUND ART

In the invention of Patent Document 1, helium is collected and recycled from exhaust gas after atmospheric-pressure plasma processing.

In the invention of Patent Document 2, a fluorine material such as CF₄ or SF₆ is separated and collected from exhaust gas by a polymer membrane in a semiconductor process.

### PRIOR ART DOCUMENTS

### Patent Documents

Patent Document 1: Japan Patent Application Publication No. 2004-14628

Patent Document 2: Japan Patent Publication No. 3151151

### SUMMARY OF INVENTION

### Problem to be Solved by Invention

Compared with vacuum plasma processing, in atmospheric-pressure plasma processing, in which no vacuum equipment is required and a plurality of substrates can be continuously processed, reduction in cost and enhancement in processing capacity can be achieved. However, the amount of processing gas required is several times larger, and therefore, when the processing gas is expensive, running cost can be high. When the processing gas is greenhouse gas, the atmospheric-pressure plasma processing is disadvantageous in view of environmental protection. Among gases that are expensive and that have high warming potential are fluorine materials such as CF₄ and SF₆. Advantages of the atmospheric-pressure plasma processing over the vacuum plasma processing are diminished by use of such fluorine materials.

A helium recovery system is provided in the atmospheric-pressure plasma processing apparatus of Patent Document 1. However, concentration of collected gas and recovery rate of the collected gas fluctuates greatly when flow rate of processing gas is changed.

In the invention of Patent Document 2, CF₄ concentration of collected gas is brought to as close to 100% as possible by a refining machine including a condenser. However, a refining machine is expensive. Moreover, CF₄ can also be lost at the refining machine, which reduces total recovery rate.

Moreover, Patent Document 2 also discloses directly introducing the collected gas to a semiconductor manufacturing process without passing the collected gas through the refining machine. However, CF₄ concentration of unrefined collected gas tends to fluctuate greatly, making it difficult to secure stability of processing.

### Solution to Problem

In view of the above, the present invention provides an atmospheric-pressure plasma processing method including:

a processing step of processing a surface of a substrate by plasmatizing (including decomposition, excitation, activation and ionization) a processing gas including a fluorine raw material under near atmospheric pressure and by bringing the processing gas into contact with the substrate;

a separating step of separating an exhaust gas generated in the processing step by a separation membrane into a collected gas in which the fluorine raw material is condensed to less than 100% and a release gas in which the fluorine raw material is diluted;

and a recycling step of utilizing the collected gas as at least a part of the processing gas;

wherein the separating step includes regulating a physical quantity of at least two gases of the collected gas, the release gas and the exhaust gas according to a flow rate of the processing gas so that either one or both of a rate (referred to as “recovery rate” hereinafter) of the fluorine raw material to be collected as the collected gas in the exhaust gas and a concentration (referred to as “recovery concentration” hereinafter) of the fluorine raw material in the collected gas are as desired, and wherein the physical quantity is related to the separation.

In the atmospheric-pressure plasma processing according to the method of the present invention, the fluorine raw material in the exhaust gas can be collected and recycled as the processing gas. Therefore, a running cost can be restrained and an environmental load can be reduced. Thus, the advantages of the atmospheric-pressure plasma processing over the vacuum plasma processing (reduction in cost, enhancement of processing capacity, etc.) can be fully taken. Moreover, fluctuation of the recovery rate or the fluctuation of the recovery concentration can be restrained by the regulation operation, and thereby stability of processing can be secured. Refining of the collected gas is not required. This can prevent increase in cost and avoid deterioration of the recovery rate.

The near atmospheric-pressure refers to a pressure in the range of 1.013×10⁴ to 50.663×10⁴ Pa. Considering the ease of pressure regulation and the simplicity of the structure of the apparatus, a pressure in the range of 1.333×10⁴ to 10.664×10⁴ Pa is preferable and a pressure in the range of 9.331×10⁴ to 10.397×10⁴ Pa is more preferable.

The “collected gas in which the fluorine raw material is condensed to less than 100%” means that the collected gas contains not only the fluorine raw material but also impure substance other than the fluorine raw material in low concentration.

The physical quantity related to the separation refers to attributes of gas that can be factors affecting separating action of the separation membrane.

The physical quantity related to the separation may be pressure, flow velocity, flow rate and temperature, etc. of at least two gases of the collected gas, the release gas and the exhaust gas.

Preferably, the physical quantity is the gas pressure. In this case, the separating action can be surely controlled. The gas pressure may be pressure of each of the gases or may be differential pressure between the gasses.

Of the collected gas, the release gas and the exhaust gas, preferably, at least the collected gas is included in the gas whose physical quantity is to be regulated. In other words, it is preferable that one of the two gasses is the collected gas. In this case, the fluctuation of the recovery rate or the recovery concentration can be more surely restrained, and the stability of processing can be more surely secured.

It is more preferable that the two gasses are the collected gas and the release gas. In this case, the fluctuation of the recovery rate or the fluctuation of the recovery concentration can be further surely restrained, and the stability of processing can be further surely secured.

The two gasses may be the collected gas and the exhaust gas, or the release gas and the exhaust gas.

The physical quantity of three of the gasses, i.e., the collected gas, the release gas and the exhaust gas may be regulated. Alternatively, the physical quantity of either one of the collected gas, the release gas and the exhaust gas may be regulated.

Preferably, a relationship obtaining step of obtaining data regarding relationship between the flow rate of the processing gas and the physical quantity that allows either one or both of the recovery rate and the recovery concentration to be as desired is performed prior to the processing step. It is preferable that the separating step includes regulating the physical quantity based on the relationship data

Preferably, a desired value of the recovery rate is set so that an amount of the fluorine raw material in the release gas is less than or equal to an allowable release amount.

This enables the environmental load to be surely reduced.

Preferably, a desired value of the recovery concentration is set so that a concentration of impure substance in the collected gas is less than or equal to an allowable amount of impure substance in the processing step.

This enables the stability of processing to be surely secured.

Preferably, the desired value of the recovery concentration is set and the flow rate of the processing gas is set so that an amount of the fluorine raw material in the processing gas is not less than a stoichiometrically required amount thereof for generating reactive components of the surface processing, and wherein a decomposition rate at the time of the plasmatization is taken into account in the stoichiometrically required amount.

This enables the stability of processing to be secured even when the recovery concentration fluctuates or even when the actual decomposition rate fluctuates.

Preferably, the processing step includes adding water to the processing gas, wherein hydrogen fluoride is generated as reactive components of the surface processing by plasmatization of the fluorine raw material and the water

and the method comprises setting the desired value of the recovery concentration and setting the flow rate of the processing gas so that an amount of the fluorine raw material in the processing gas is excessive with respect to a stoichiometrically required amount thereof based on an added amount of the water for the generation of hydrogen fluoride, and wherein a decomposition rate at the time of the plasmatization is taken into account in the stoichiometrically required amount.

This enables the stability of processing to be surely secured even when the recovery concentration fluctuates or even when the actual decomposition rate fluctuates. By adjusting the added amount of water, a generated amount of the hydrogen fluoride can be adjusted, and thereby a degree of processing can be adjusted. It is not required to precisely control the flow rate of the processing gas.

Preferably, the recycling step includes replenishing the collected gas with a certain amount of the fluorine raw material.

This enables an amount of the fluorine raw material consumed in the surface processing to be replenished. This also enables an amount of the fluorine raw material contained in the release gas and released out of the system to be replenished. Thus the system can be constantly operated. It is preferable that the amount of replenishment is also taken into consideration when settings are made so that the amount of the fluorine raw material in the processing gas is not less than the stoichiometrically required amount or excessive with respect to the stoichiometrically required amount.

A plasma processing apparatus according to the present invention comprises:

a processing part that plasmatizes a processing gas including a fluorine raw material under near atmospheric pressure and brings the processing gas into contact with a substrate to perform a surface processing of the substrate;

a separation part that separates an exhaust gas from the processing part by a separation membrane into a collected gas in which the fluorine raw material is condensed to less than 100% and a release gas in which the fluorine raw material is diluted;

a recycling part that utilizes the collected gas as at least a part of the processing gas;

a flow rate controller that controls a flow rate of the processing gas;

a regulator that regulates a physical quantity of at least two gases of the collected gas, the release gas and the exhaust gas, wherein the physical quantity is related to the separation;

and a regulation controller for the regulator;

wherein the regulation controller includes a data storage part that stores relationship data regarding relationship between the flow rate of the processing gas and the physical quantity, wherein the relationship allows either one or both of a rate (referred to as “recovery rate” hereinafter) of the fluorine raw material to be collected as the collected gas in the exhaust gas and a concentration (referred to as “recovery concentration” hereinafter) of the fluorine raw material in the collected gas to be as desired, and wherein the regulation controller controls the regulator based on a controlled flow rate (can be either a setting value or the flow rate as a result of control) by the flow rate controller and the relationship data.

In the atmospheric-pressure plasma processing apparatus according to the present invention, the fluorine raw material in the exhaust gas can be collected and recycled as the processing gas. Therefore, a running cost can be restrained and an environmental load can be reduced. Thus, the advantages of the atmospheric-pressure plasma processing apparatus over the vacuum plasma processing apparatus (cost reduction, enhancement of processing capacity, etc.) can be fully exploited. Moreover, fluctuation of the recovery rate or the recovery concentration can be restrained, and stability of processing can be secured. Refining of the collected gas is not required. This can prevent increase in cost and avoid deterioration of the recovery rate.

The physical quantity may include pressure, flow velocity, flow rate and temperature. The regulator may be a gas pressure regulator (valve, pump, etc.), a flow velocity regulator (valve, pump, etc.), a flow rate regulator (valve, pump, etc.) and a temperature regulator (electrothermal heater, heat exchanger, cooler, etc.), As a detector to detect the physical quantity, a pressure sensor, a current meter or a thermometer may be disposed.

Preferably, the regulator includes a gas pressure regulator that regulates pressure of the two gases.

This enables the separating action in the separation part to be surely controlled, thereby stability of processing can be surely secured. In this case, the physical quantity is the pressure of the two gases. It is preferable that the relationship data are data regarding relationship between the flow rate of the processing gas and the pressure of the two gases.

Preferably, the regulator includes a collected gas pressure regulator that regulates pressure of the collected gas and a release gas pressure regulator that regulates pressure of the release gas.

This enables the separation action in the separation part to be more surely controlled, thereby stability of processing can be more surely secured. In this case, the physical quantity is the pressure of the collected gas and the release gas. It is preferable that the relationship data are data regarding relationship between the flow rate of the processing gas and the pressure of the collected gas and the release gas. The relationship data may include data regarding the relationship between the flow rate of the processing gas and the pressure of the collected gas and data regarding the relationship between the pressure of the collected gas and the pressure of the release gas. The relationship data may include data regarding the relationship between the flow rate of the processing gas and the pressure of the release gas and data regarding the relationship between the pressure of the collected gas and the pressure of the release gas.

Preferably, the relationship data are set so as to achieve a recovery rate at which the fluorine raw material in the release gas is less than or equal to an allowable release amount.

This enables the environmental load to be surely reduced.

Preferably, the relationship data are set so as to achieve a recovery concentration at which the concentration of impure substance in the collected gas is less than or equal to an allowable amount of impure substance in the processing part.

This enables the stability of processing to be surely secured.

Preferably, the controlled flow rate by the flow rate controller and the relationship data are set so that an amount of the fluorine raw material in the processing gas is not less than a stoichiometrically required amount thereof for generating reactive components of the surface processing, and wherein a decomposition rate at the time of the plasmatization is taken into account in the stoichiometrically required amount.

This enables the stability of processing to be surely secured even when the recovery concentration fluctuates or even when the actual decomposition rate fluctuates.

Preferably, the apparatus further includes an adding device by which water is added to the processing gas, hydrogen fluoride is generated as reactive components of the surface processing by plasmatization of the fluorine raw material and the water and the controlled flow rate by the flow rate controller is set and the relationship data are set so that an amount of the fluorine raw material in the processing gas is excessive with respect to a stoichiometrically required amount thereof based on an added amount of the water for the production of hydrogen fluoride, and wherein a decomposition rate at the time of the plasmatization is taken into account in the stoichiometrically required amount.

This enables the stability of processing to be surely secured even when the recovery concentration fluctuates or even when the actual decomposition rate fluctuates. By regulating the added amount of water, a generated amount of the hydrogen fluoride can be regulated, and thereby a degree of processing can be regulated. It is not required to precisely control the flow rate of the processing gas.

Preferably, a replenishment part that replenishes the collected gas with a certain amount of the fluorine raw material is connected to the recycling part.

This enables an amount of the fluorine raw material consumed in the surface processing to be replenished. This also enables an amount of the fluorine raw material contained in the release gas and released out of the system to be replenished. Thus the plasma processing apparatus can be constantly operated. It is preferable that the amount of replenishment should be taken into consideration when settings are made so that the amount of the fluorine raw material in the processing gas is not less than the stoichiometrically required amount or excessive with respect to the stoichiometrically required amount.

Preferably, the separation part includes a plurality of steps of separators, each of the separators is partitioned by a separation membrane into a first chamber and a second chamber, the exhaust gas is introduced to the first chamber in the first step, the first chambers in the plurality of steps are connected in series, the collected gas is led out of the first chamber in the last step and the release gas is led out of the second chamber in each of the steps.

By this arrangement, the recovery concentration can be increased.

The processing part may include a chamber having an opening always open to the atmospheric-pressure environment and the opening may serve as an entrance port or an exit port for the substrate.

This enables a plurality of substrates to be easily carried into the chamber, surface-processed and carried out of the chamber in a continuous fashion.

The exhaust gas may contain the processing gas after the processing and ambient gas sucked in from inside the chamber. The fluorine raw material can be separated and recovered from the exhaust gas including the ambient gas. In this case, the flow rate of the exhaust gas is greater than the flow rate of the processing gas. The processing gas after the processing in the exhaust gas may be of a small amount and the ambient gas may be of a great amount. The collected gas may be of a small amount and the release gas may be of a great amount.

### Advantageous Effects of Invention

According to the present invention, running cost can be restrained and environmental load can be reduced. Moreover, fluctuation of the recovery rate or the recovery concentration can be restrained, and stability of processing can be secured.

### BRIEF DESCRIPTION OF DRAWINGS

FIG. 1 is a schematic configuration diagram of an atmospheric-pressure plasma processing apparatus according to a first embodiment of the present invention.

FIG. 2 is a graph showing an example of relationship data of a gas physical quantity with respect to flow rates of processing gas.

FIG. 3 is a schematic configuration diagram of a part of an atmospheric-pressure plasma processing apparatus according to a second embodiment of the present invention.

FIG. 4 is a graph showing results of an example 1.

### DESCRIPTION OF EMBODIMENTS

Embodiments of the present invention will be described hereinafter with reference to the drawings.

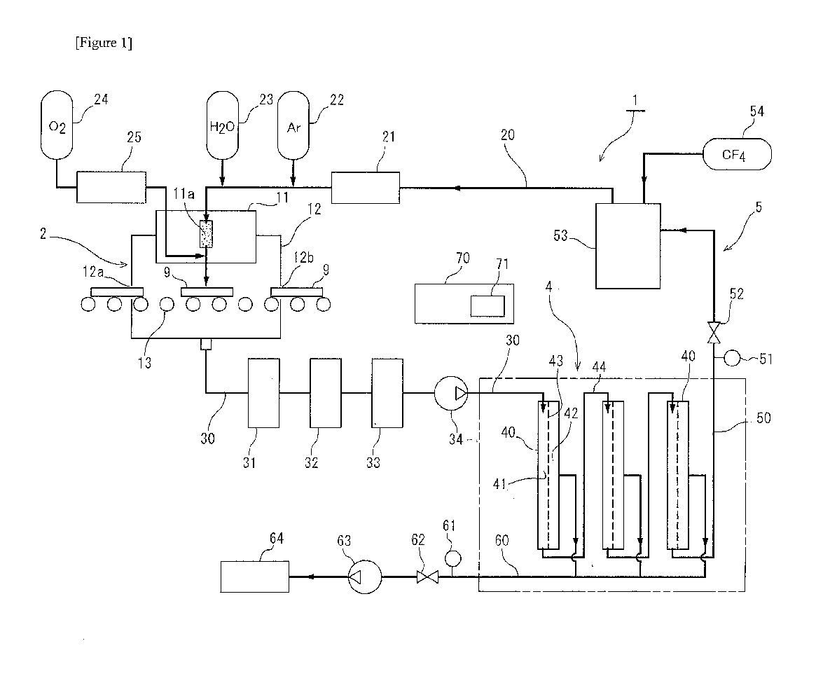

FIG. 1 shows a first embodiment. A substrate 9 is a glass substrate for a flat panel display, for example. Though not shown in the drawings, an amorphous silicon film is formed on the substrate 9. The film is to be etched by an atmospheric-pressure plasma processing apparatus 1. A film to be etched is not limited to the amorphous silicon, but may be monocrystalline silicon or polycrystalline silicon.

The atmospheric-pressure plasma processing apparatus 1 includes an atmospheric-pressure plasma processing part 2 and a separation part 4. The processing part 2 has an atmospheric-pressure plasma head 11, a chamber 12 and a conveyer 13. The plasma head 11 is disposed under atmospheric pressure or near atmospheric pressure. Though not shown in detail in the drawings, the atmospheric-pressure plasma head 11 has at least a pair of electrodes. A discharge space 11a of almost atmospheric pressure is formed by applying electric fields to between the electrodes.

A processing gas line 20 continues to an upstream end of the discharge space 11a. Main component of processing gas to be flowed through the processing gas line 20 is fluorine raw material. In this embodiment, CF₄ is used as the fluorine raw material. Other PFCs (perfluorocarbons) such as C₂F₆ and C₃F₈, HFCs (hydrofluorocarbons) such as CHF₃, CH₂F₂ and CH₃F and fluorine-containing compounds other than PFCs and HFCs such as SF₆, NF₃ and XeF₂ may be used as the fluorine raw material instead of the CF₄.

A flow rate controller 21 is disposed in the processing gas line 20. The flow rate controller 21 is a mass flow controller. A flow rate input part for inputting a set flow rate of the processing gas is attached to the mass flow controller 21. The mass flow controller 21 controls a flow rate of the processing gas in the line 20 so that the flow rate becomes the set flow rate.

The processing gas flowing through the mass flow controller 21 is almost entirely composed of CF₄. Therefore, the mass flow controller 21 may be a mass flow controller that detects a flow rate of CF₄.

The flow rate controller 21 is not limited to the mass flow controller, but may be a flow rate control valve.

An inert gas supply line 22 is connected to the processing gas line 20 at a point nearer to the plasma head 11 than the flow rate controller 21. The supply line 22 merges inert gas such as argon (Ar) into the processing gas line 20, thereby diluting the CF₄ with Ar. Other inert gases such as He may be used as the gas for diluting the CF₄ in place of Ar.

A water adding device 23 is connected to the processing gas line 20 at a point more downstream than the dilution gas supply line 22. The water adding device 23 vaporizes water (H₂O) by bubbling or heating and adds the vaporized water to the processing gas line 20, thereby humidifying the processing gas.

The water adding device 23 may be a sprayer.

The humidified processing gas (CF₄+Ar+H₂O) is introduced to the atmospheric-pressure discharge space 11a and plasmatized (including decomposition, excitation, activation, radicalization and ionization). As a result of the plasmatization, fluorine reaction components such as HF and COF₂, etc. are generated. A reaction formula for generating HF is given below:

CF₄+2H₂O→4HF+CO₂ (expression 1)

The plazmatized processing gas will be referred to as “plasma gas” hereinafter where appropriate.

An oxidizing gas supply line 24 is connected to the processing gas line 20 at a point more downstream than the atmospheric-pressure discharge space 11a. An ozonizer 25 is disposed in the oxidizing gas supply line 24. The ozonizer 25 produces ozone (O₃) as an oxidizing reaction component from oxygen (O₂) as a raw material. A produced amount of the ozone is about 8% of the raw material (O₂). Gas containing ozone (O₃+O₂) from the ozonizer 25 is merged into the plasma gas. The plasma gas after the merging is downwardly blown out of the atmospheric-pressure plasma head 11. The plasma gas and the gas containing ozone may be blown out form separate blow-off openings without being blended.

The atmospheric-pressure plasma head 11 is disposed in an upper portion of the chamber 12. Inside the chamber 12 is of near atmospheric-pressure. Openings 12a, 12b are provided in walls at opposite sides of the chamber 12. The openings 12a, 12b are always open. The opening 12a is an entrance port for the substrate 9. The opening 12b is an exit port for the substrate 9.

The conveyor 13 is disposed inside the chamber 12 and outside of the opposite walls of the chamber 12. The conveyor 13 functions as a transporter and a supporter for the substrate 9. A plurality of substrates 9 are put on the conveyor 13 in a row. The plurality of substrates 9 are sequentially brought into the chamber 12 by the conveyor 13 via the entrance port 12a and transversely moved below the atmospheric-pressure plasma head 11. The plasma gas from the atmospheric-pressure plasma head 11 is blown out toward the substrates 9, thereby silicon etching is performed. After that, each of the substrates 9 is brought outside by the conveyor 13 via the exit port 12b.

The transporter and the supporter for the substrates 9 is not limited to the conveyor 13, but may be a movable stage, a floating stage by gas pressure or a robot arm. The substrate 9 may have a continuous sheet configuration and a transporter and a supporter for the substrate 9 having the continuous sheet configuration may be a guide roll.

The entrance port 12a and the carry-out exit 12b may be opened only when the substrate 9 passes through the openings and may be closed after the substrate 9 is brought into the chamber 12 or after the substrate 9 is carried out of the chamber 12.

The chamber 12 may be provided with the only one opening. The substrate 9 may be brought into the chamber 12 via the one opening and carried out of the chamber 12 via the one opening after the processing.

An exhaust gas line 30 is drawn out from the chamber 12. A basal end portion of the exhaust gas line 30 is connected to a bottom portion, for example, of the chamber 12.

Though not shown in the drawings, a suction opening is provided near the processing gas blow-off opening of the plasma head 11. A suction passage extends from the suction opening. The suction passage is merged into the exhaust gas line 30.

A scrubber 31, a mist trap 32, an ozone killer 33 and a compressor 34 are disposed in the exhaust gas line 30 in this order from the upstream side (the chamber 12 side). The gas inside the chamber 12 (including the gas near the suction opening) is exhausted to the exhaust gas line 30 by the actuation of the compressor 34. The processing gas after the processing (referred to as “post⁻processing gas” hereinafter) is contained in the exhaust gas. In addition to the reaction by-products of the etching (SiF₄, etc.), reactive components (HF, O3, etc.) that have not contributed to the etching reaction and processing gas components (CF₄, Ar, H₂O) that have not been plasmatized in the atmospheric-pressure discharge space 11a are contained in the post-processing gas. Moreover, in addition to the post-processing gas, the exhaust gas contains a great deal of ambient gas suctioned from the chamber 12, i.e. air. Therefore, a great deal of nitrogen (N₂) is contained in the exhaust gas. Components of the exhaust gas other than CF₄ are referred to as “impure substance” hereinafter. Majority of the impure substance is the nitrogen. A flow rate of the exhaust gas is sufficiently greater than the flow rate of the processing gas led to the atmospheric-pressure plasma head 11.

The scrubber 31, which is a water scrubber or an alkaline scrubber, removes HF, etc. from the exhaust gas. The mist trap 32 removes water content (H₂O) from the exhaust gas. The ozone killer 33 removes the ozone (O₃) from the exhaust gas using an adsorbent or a reduction catalyst such as activated carbon. The exhaust gas line 30 extends to the separation part 4.

The separation part 4 includes a plurality of steps (three steps in the drawings) of separators 40. A separation membrane 43 is provided inside each of the separators 40. A glassy polymer membrane (see Patent Document 2), for example, is used as the separation membrane 43. Permeation rate of the nitrogen (N₂) through the separation membrane 43 is relatively great and permeation rate of CF₄ is relatively small.

An inner space of the separator 40 is partitioned into a first chamber 41 and a second chamber 42 by the separation membrane 43. A downstream end of the exhaust gas line 30 continues to an entrance port of the first chamber 41 of the separator 40 in the first step. An exit port of the first chamber 41 in each step continues to the entrance port of the first chamber 41 in the next step via a connecting passage 44. Therefore, the first chambers 41 in all the steps are connected in series. The exhaust gas is delivered to the first chambers 41 in the plurality of steps in sequence. In each of the steps, a part of the exhaust gas permeates the separation membrane 43 and flows into the second chamber 42. Due to a difference in the permeation rate through the separation membrane 43, the concentration of CF₄ is higher in the first chamber 41 and the concentration of the impure substance chiefly composed of nitrogen is higher in the second chamber 42.

A collected gas line 50 extends from the exit port of the first chamber 41 in the last step. The collected gas line 50 is drawn out from the separation part 4. The gas sent from the first chamber 41 in the last step to the collected gas line 50 is referred to as “collected gas” hereinafter. The collected gas contains high concentration (not less than 90%, for example) of CF₄ and low concentration (less than 10%, for example) of the impure substance. Concentration of CF₄ in the collected gas is referred to as “recovery concentration” or “collected CF₄ concentration” as appropriate hereinafter. A flow rate of the collected gas is sufficiently smaller than the flow rate of the exhaust gas flowing through the exhaust gas line 30. A collected gas pressure sensor 51 and a collected gas pressure regulator 52 are disposed in the collected gas line 50 in this order from the upstream side. Pressure of the collected gas led out from the separation part 4 (collected gas physical quantity) is detected by the pressure sensor 51. The pressure sensor 51 constitutes a collected gas physical quantity detector. The collected gas pressure regulator 52 is constituted by an automatic pressure control valve and automatically controls the pressure of the collected gas led out from the separation part 4.

The collected gas line 50 is connected to a mixing tank 53. A CF₄ replenishment part 54 that is a tank containing the CF₄ of 100% concentration is connected to the mixing tank 53. The collected gas from the collected gas line 50 and pure CF₄ gas from the replenishment part 54 are mixed in the mixing tank 53. An amount of replenishment of the pure CF₄ gas can be set in consideration of an amount of CF₄ consumed in the etching process in the processing part 2 and an amount of CF₄ released from a release line 60 to be described later.

In addition to CF4, impure substance (mainly nitrogen) of several to 10% concentration is contained in a mixed gas in the tank 53. The mixed gas is the processing gas before Ar is mixed and before H₂O is added. The processing gas line 20 extends to the atmospheric-pressure plasma head 11 from the mixing tank 53.

The gas lines 20, 50 and the mixing tank 53 constitute a CF₄ recycling part 5.

The release gas line 60 extends from the second chamber 42 of each of the separators 40. The gas sent from the each of the second chambers 42 to the release gas line 60 is referred to as “release gas” hereinafter. The majority of the release gas is composed of the impure substance (mainly nitrogen) and contains a slight amount of CF₄. A concentration of the impure substance in the release gas is greater than a concentration of the impure substance in the exhaust gas. A concentration of CF₄ in the release gas is sufficiently smaller than the concentration of CF₄ in the exhaust gas.

The release gas lines 60 from the second chambers 42 are merged with each other and drawn out from the separation part 4. A release gas pressure sensor 61 and a release gas pressure regulator 62 are disposed in the release gas line 60 after the merger in this order. A pressure (release gas physical quantity) of the release gas led from the separation part 4 is detected by the pressure sensor 61. The pressure sensor 61 constitutes a release gas physical quantity detector. The release gas pressure regulator 62 is constituted by an automatic pressure control valve and automatically controls the pressure of the release gas led from the separation part 4.

A portion of the release gas line 60 located more downstream than the pressure control valve 62 is connected to a detoxifier 64 via a suction pump 63. The release gas from the second chambers 42 are merged with each other and sent to the detoxifier 64 via the line 60. The flow rate of the release gas after the merger is generally the same as the flow rate of the exhaust gas, but slightly smaller than the flow rate of the exhaust gas. After being detoxified by the detoxifier 64, the release gas is released to the atmosphere.

The atmospheric-pressure plasma processing apparatus 1 further includes an regulation controller 70 for the regulators 52, 62. Though not shown in detail in the drawings, the regulation controller 70 includes a micro computer and drive circuits for the pressure control valves 52, 62, etc. The micro computer includes an input/output interface, a CPU, a RAM, and a ROM 71, etc. Programs and data necessary for the control are stored in the ROM 71. Among the data necessary for the control are relationship data between the flow rate of the processing gas and a physical quantity related to the membrane separation at the separation part 4. The ROM 71 constitutes a relationship data storage part.

The regulation controller 70 may be composed of analog circuits.

The physical quantity related to the membrane separation may be pressure, flow rate, flow velocity or temperature, for example, of gas and may preferably be the pressure. The subject gases are three: the collected gas, the release gas and the exhaust gas. Of these three gases, it is preferable that two gases including at least the collected gas should be the subject gases.

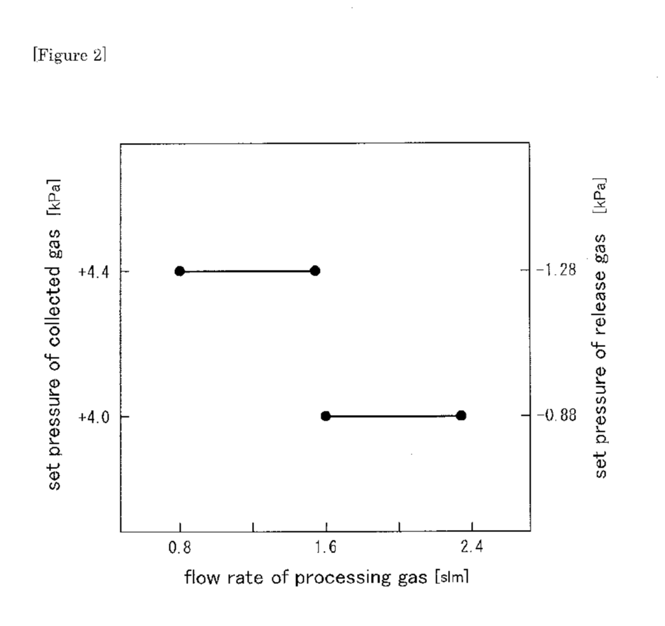

For example, as exemplarily shown in FIG. 2, data regarding set pressures of the collected gas and set pressures of the release gas with respect to the flow rate of the processing gas are stored in the ROM 71 of the controller 70 as the relationship data. The flow rate of the processing gas in a horizontal axis of FIG. 2 shows the flow rate of the processing gas before the argon is merged and before the water is added, which is the flow rate controlled by the mass flow controller 21. Since the processing gas flowing through the mass flow controller 21 is substantially CF₄ as mentioned above, the horizontal axis of FIG. 2 may represent the flow rate of CF₄. Set pressures of the collected gas and set pressures of the release gas in a vertical axis of FIG. 2 respectively represent differential pressures with respect to the atmospheric pressure. The set pressures of the collected gas are positive pressures. The set pressures of the release gas are negative pressures. The set pressures of the release gas are uniquely determined with respect to the set pressures of the collected gas.

The set pressure of the collected gas and the set pressure of the release gas are constant for each of certain ranges of the flow rate of the processing gas. As the range of the flow rate shifts, the set pressure of the collected gas and the set pressure of the release gas change in a stepwise fashion. The set pressure of the collected gas (positive pressure) as difference from the atmospheric pressure is greater in a positive direction when the range of the flow rate of the processing gas is of smaller value and the difference from the atmospheric pressure is gradually decreased as the range of the flow rate of the processing gas is of increased value. The set pressure of the release gas (negative pressure) as difference from the atmospheric pressure is greater in a negative direction when the range of the flow rate of the processing gas is of smaller value and the difference from the atmospheric pressure is gradually decreased as the range of the flow rate of the processing gas is of increased values.

The regulation controller 70 controls the pressure control valves 52, 62 based on the flow rate of the processing gas at the mass flow controller 21, detected signals by the pressure sensors 51, 61 and the relationship data in the ROM 71, and feed-back controls the collected gas pressure and the release gas pressure so that the collected gas pressure and the release gas pressure respectively are the set pressures.

A method of surface processing the substrate 9 by the atmospheric-pressure plasma processing apparatus 1 is described below.

### [Relationship Obtaining Step]

Prior to the surface processing of the substrate 9, the relationship data between the flow rate of the processing gas and the physical quantity related to the membrane separation (FIG. 2) are obtained

In the relationship obtaining step, concentration detectors are respectively disposed in the exhaust gas line 30 and the release gas line 60. A Fourier transform infrared spectroscopy analyzer (FTIR) can be used as the concentration detector, for example. The atmospheric-pressure plasma processing apparatus 1 is preliminarily run. Operations of the processing part 2 and the separation part 4, etc. in the preliminary running are the same as those in a processing step to be described later. A real sample of the substrate 9 is surface processed. Then, CF₄ concentration P_{A} in the exhaust gas and CF₄ concentration P_{B} in the release gas are detected by the concentration detectors. Rate of the CF₄ recovered as the collected gas from the exhaust gas, i.e. a recovery rate of CF₄ is calculated from the detected concentrations P_{A}, P_{B}. Since the flow rate of the release gas is almost the same as the flow rate of the exhaust gas, the recovery rate can be approximated as: recovery rate=(P_{A}−P_{B})/P_{A}.

Collected CF₄ concentration also is detected. The collected CF₄ concentration can be detected by disposing a concentration detector such as FTIR in the gas line 50 or 20. The collected CF₄ concentrations may be calculated from the recovery rate and the flow rate of the collected gas.

The pressure of the collected gas is regulated by operating the pressure control valve 52 so that the both or either one of the recovery rate and the collected CF₄ concentration is as desired and the pressure of the release gas is regulated by operating the pressure control valve 62. The pressure of the collected gas is read at the pressure sensor 51. The pressure of the release gas is read at the pressure sensor 61. The flow rate of the processing gas is read at the mass flow controller 21. Based on these readouts, the set pressure of the collected gas and the set pressure of the release gas with respect to the flow rate of the processing gas are obtained and the flow rate-physical quantity relationship data are prepared.

A desired value of the recovery rate can be determined based on allowable release amount of CF₄ based on laws and voluntary regulations, for example in a range of 95 to 98%.

A desired value of the collected CF₄ concentration can be set so that the impure substance in the processing gas is at least less than or equal to the allowable amount, for example in a range of 92 to 98%.

Moreover, it is preferable that the desired value of the collected CF₄ concentration may be determined so that the processing gas satisfies the following expression 2, more preferably the following expression 3:

(mF×p)≧(mH/2)×(1/ε) (expression 2)

(mF×p)>>(mH/2)×(1/ε) (expression 3)

The sign >> in the expression 3 means that the value in the left-hand side (mF×p) is sufficiently greater (excessive) than the value in the right-hand side (mH/2)×(1/ε). Here, mF is the flow rate of the entirety of the processing gas at the mass flow controller 21. p is the CF₄ concentration in the processing gas. Therefore, the value in the left-hand side (mF×p) in the expressions 2 and 3 are molar flow rates of the CF₄ in the processing gas. mH is an added amount of H₂O (molar flow rate) by the water addition line 23. Since the molar ratio of CF₄ and H₂O related to the generation of HF is: CF₄:H₂O=1:2 as shown in the expression 1, (mH/2) is a stoichiometrically required amount of CF₄ for the production of HF based on the added amount of H₂O. ε is a decomposition rate of CF₄ in the atmospheric-pressure discharge space 11a. Generally, ε is about ε=0.1. Therefore, the values (mH/2)×(1/ε) in the right hand side of the expressions 2 and 3 are stoichiometrically required amounts of CF₄ in which the decomposition rate of CF₄ in the atmospheric-pressure discharge space 11a is taken into account.

Alternatively, the CF₄ concentration of the processing gas may be detected by a CF₄ concentration monitor disposed in the processing gas supply line, or may be calculated from the CF₄ concentration of the collected gas and the flow rate of the collected gas and the replenished amount of CF₄ pure gas from the CF₄ replenishment part 54.

The recovery rate and the collected CF₄ concentration have an opposite relation to each other. As the recovery rate is increased, the collected CF₄ concentration is decreased. As the collected CF₄ concentration is increased, the recovery rate is decreased.

When the flow rate of the processing gas is small, the allowable release amount of CF₄ can be sufficiently met. Therefore, the desired value of the collected CF₄ concentration can be set high by priority. In this case, the recovery rate becomes relatively low.

When the flow rate of the processing gas is increased with the recovery rate being constant, a release flow rate of CF₄ is increased. Therefore, in a range where the flow rate of the processing gas is great, it is preferable that the recovery rate is given priority over the recovery concentration and the desired value of the recovery rate is set high. In this way, an increase of the released amount of CF₄ can be prevented or restrained. In this case, however, the concentration of the collected CF₄ becomes relatively low.

In an example shown in FIG. 2, in a range where the flow rate of the processing gas is relatively small (not less than 0.8 slm and less than 1.6 slm), the pressure of the collected gas is set at a relatively great value in the positive direction (+4.4 kPa) and the pressure of the release gas is set at a relatively great value in the negative direction (−1.28 kPa). Therefore, a set differential pressure between the collected gas and the release gas is relatively great. In this case, the recovery rate is about 97.0% and the collected CF₄ concentration is about 96%.

In a range where the flow rate of the processing gas is relatively great (not less than 1.6 slm and less than 2.4 slm), the pressure of the collected gas is set at a relatively small value (+4.0 kPa). The set pressure of the release gas is a relatively small value in the negative direction (−0.88 kPa). Therefore, the set differential pressure between the collected gas and the release gas is relatively small. In this case, the recovery rate is about 97.6% and the collected CF₄ concentration is about 92%.

The obtained relationship data are stored in the ROM 71.

### [Processing Step]

After that, the actual substrates 9 are surface processed.

The conveyor 13 is actuated and the plurality of substrates 9 are placed on an upstream end (left end in FIG. 1) of the conveyor 13 in a transport direction in sequence. The substrates 9 are delivered into the chamber 12 via the entrance port 12a.

The processing gas containing CF₄ and a slight amount of the impure substance is led out of the mixing tank 53 into the processing gas line 20. The flow rate of the processing gas is controlled by the mass flow controller 21. A setting value of the flow rate of the processing gas by the mass flow controller 21 preferably satisfies the expression 2, and more preferably satisfies the expression 3.

Ar from the inert gas supply line 22 is mixed to the processing gas. A mixed flow rate of Ar or a mixture ratio of Ar is adjusted as appropriate according to the processing. For example, when the flow rate of the processing gas at the mass flow controller 21 is 0.8 slm, the flow rate of mixed Ar may be 15 slm. When the flow rate of the processing gas at the mass flow controller 21 is 1.6 slm, the flow rate of mixed Ar may be 30 slm.

Moreover, a constant amount of H₂O is added to the processing gas from the water addition line 23. The added amount of H₂O preferably satisfies the expression 2, and more preferably satisfies the expression 3. As a result, the processing gas becomes CF₄ rich and H₂O poor.

The processing gas after the mixture and the addition is introduced to the atmospheric-pressure discharge space 11a of the plasma head 11 and plasmatized. HF is generated by the plasmatization. The gas containing ozone (O₂+O₃) from the oxidizing gas supply line 24 is mixed to the processing gas after the plasmatization (plasma gas). A mixed flow rate or a mixture ratio of the gas containing ozone is adjusted as appropriate according to the processing. For example, when the flow rate of the processing gas at the mass flow controller 21 is 0.8 slm, the mixed flow rate of the gas containing ozone may be 6 slm. When the flow rate of the processing gas at the mass flow controller 21 is 1.6 slm, the mixed flow rate of the gas containing ozone may be 12 slm. The plasma gas after being mixed with the ozone is blown out of the atmospheric-pressure plasma head 11. The blown out gas is blown onto the substrate 9 passed below the atmospheric-pressure plasma head 11, thereby etching a silicon film of the substrate 9.

The substrates 9 that have gone through the etching process are carried to the outside from the exit port 12b in sequence.

Since the processing is done under the atmospheric pressure, the plurality of substrates 9 can be carried into the chamber 12, etched and carried to the outside in a continuous manner. Therefore, compared with the vacuum plasma processing in which adjustment of pressure inside the chamber is required every time the substrate is carried in and carried to the outside, the amount of processing can be greatly enhanced.

Since the processing gas is CF₄ rich and H₂O poor, the amount of HF generated by the plasmatization mainly depends on the added amount of H₂O. Even when the amount of CF₄ fluctuates to some degree, the generated amount of HF is almost unchanged. Therefore, a reaction speed of the surface processing can be adjusted mainly by the added amount of H₂O. It is not required to precisely control the amount of CF₄. Even when an amount of collected CF₄ fluctuates in a separating step to be described later, influence of the fluctuation on the surface processing can be made minimum. Even when an excessive amount of CF₄ is contained in the processing gas, it is not uneconomical and does not increase the environmental load since the CF₄ is collected and recycled.

The flow rate of the processing gas supplied to the plasma head 11 can be adjusted according to the kind of surface processing. For example, when etching is performed at a high speed, the flow rate may be relatively high. When etching is performed while protecting an underlying film from damage by a high selection ratio of a film to be etched with respect to the underlying film, the flow rate may be relatively low. When the substrate 9 is located right below the plasma head 11 and is being etched, the flow rate may be relatively high and when the substrate 9 is not located right below the plasma head 11 and is not being etched, the flow rate may be relatively low.

### [Gas Exhausting Step]

Moreover, the gas inside the chamber 12 is suctioned, and led out into the exhaust gas line 30 as the exhaust gas. The exhaust gas contains a plenty of the ambient gas (air) inside the chamber 12 in addition to the components of the post-processing gas such as SiF₄, HF, O₃, O₂, CF₄, Ar and H₂O. The flow rate of the exhaust gas is sufficiently greater than the flow rate of the processing gas. For example, when the flow rate of the processing gas at the mass flow controller 21 is 0.8 to 1.6 slm, the flow rate of the exhaust gas is 200 slm. From outside of the chamber 12, the air suctioned into the exhaust gas line 30 flows into the chamber 12 via the entrance port 12a and the exit port 12b.

The HF and SiF₄ in the exhaust gas are removed by the scrubber 31. The H₂O in the exhaust gas is removed by the mist trap 32. The O₃ in the exhaust gas is removed by the ozone killer 33.

### [Separating Step]

After that, the exhaust gas is pressurized by the compressor 34, and pumped to the separation part 4. Inside the release gas line 60 and therefore the second chambers 42 of the separators 40 are suctioned by the suction pump 63. The exhaust gas is separated into the gas to stay in the first chamber 41 and the gas to flow through the separation membrane 43 to the second chamber 42 by the separation membrane 43 in each of the steps of the separation part 4. CF₄ is concentrated in the gas to stay in the first chamber 41. The gas is sent to the first chamber 41 of the separator 40 in the subsequent step in sequence, CF₄ being sufficiently concentrated, and from the first chamber 41 in the last step led out to the collected gas line 50 as the collected gas.

CF₄ in the gas that permeates the separation membrane 43 and transfers to the second chamber 42 is diluted, and the gas is composed mostly of impure substance (mainly nitrogen) other than CF₄. The gas is led out as the release gas to the release gas line 60 from the second chamber 42 in each of the steps. A flow rate of the release gas is slightly smaller than that of the exhaust gas. For example, when the flow rate of the exhaust gas is 200 slm, the flow rate of the release gas is from about 198 slm to less than 200 slm. Difference between the flow rates of the exhaust gas and the release gas is the flow rate of the collected gas.

Since the O₃ in the exhaust gas is removed by the ozone killer 33 before the separating step, damage to the separation membrane 43 can be prevented.

A physical quantity related to the separation is regulated according to the flow rate of the processing gas in the separating step. The pressures of the collected gas and the release gas are regulated in this embodiment.

Specifically, the collected gas pressure is detected by the pressure sensor 51. The release gas pressure is detected by the pressure sensor 61. The detected values are input to the regulation controller 70. Moreover, the flow rate of the processing gas controlled by the mass flow controller 21 is entered to the regulation controller 70. The controlled flow rate is the flow rate as a result of the control by the mass flow controller 21 in this embodiment, but the controlled flow rate may be the control target value set at the flow rate input part. The regulation controller 70 controls the pressure control valves 52, 62 using the relationship data in the built-in ROM 71 so that the detected pressures at the pressure sensors 51, 61 respectively are predetermined values according to the processing gas flow rate.

This restrains the fluctuation of the recovery rate and the fluctuation of the collected CF₄ concentration. Even when the flow rate of the processing gas fluctuates by several-fold, the recovery rate can be constantly maintained in the range of about 95 to 98% and the collected CF₄ concentration can be constantly maintained in the range of about 92 to 98%. When the flow rate of the processing gas is constant, a fluctuation range of the collected CF₄ concentration can be restrained to 0.5% or less, thus preventing an impact on the processing. This enables the stability of processing to be secured.

Specifically, let us consider a case in which the relationship data as shown in FIG. 2 are obtained in the relationship obtaining process. If the flow rate of the processing gas at the mass flow controller 21 is not less than 0.8 slm and less than 1.6 slm, the pressure control valve 52 is controlled so that the collected gas pressure is +4.4 kPa with respect to the atmospheric pressure and the pressure control valve 62 is controlled so that the release gas pressure is −1.28 kPa with respect to the atmospheric pressure. This makes the recovery rate about 97.0%, which falls within the desired range. Moreover, this makes the collected CF₄ concentration about 96%, which falls within the desired range.

If the flow rate of the processing gas at the mass flow controller 21 is not less than 1.6 slm and less than 2.4 slm, the pressure control valve 52 is controlled so that the collected gas pressure is +4.0 kPa with respect to the atmospheric pressure and the pressure control valve 62 is controlled so that the release gas pressure is −1.28 kPa with respect to the atmospheric pressure. This makes the recovery rate about 97.6%, which falls within the desired range. Moreover, this makes the collected CF₄ concentration about 92%, which falls within the desired range.

When the flow rate of the processing gas is small, the collected CF₄ concentration can be made high. Therefore, the amount of the impure substance supplied to the atmospheric-pressure plasma processing part 2 can be reduced, thereby surely enhancing quality of the processing.

When the flow rate of the processing gas is great, the recovery rate can be made high. Therefore, CF₄ can be prevented from being released in an amount exceeding the allowable limit.

Since the set pressures of the collected gas and the release gas are constant for each of the certain ranges of the flow rate of the processing gas, it is not required to change the set pressures of the collected gas and the release gas even if the flow rate of the processing gas fluctuates as long as the flow rate falls within the same range. This makes the control easy.

### [Recycling Step]

The collected gas is sent to the mixing tank 53. At the same time, CF₄ pure gas is sent to the mixing tank 53 from the CF₄ replenishment part 54. The collected gas and the CF₄ pure gas are mixed in the mixing tank 53. This enables CF₄ consumed in the etching process to be replenished. This also enables CF₄ released out of the system in a releasing process to be described later to be replenished. Thus, the plasma processing apparatus 1 can be constantly operated.

As a result of the mixing in the tank 53, the processing gas containing higher concentration of CF₄ than the collected gas is produced. The processing gas is sent to the atmospheric-pressure plasma processing part 2 via the processing gas line 20 to be used for the etching process.

### [Releasing Step]

After being sent to the detoxifier 64 and detoxified by the detoxifier 64, the release gas is released to the atmosphere. Since the CF₄ is sufficiently collected at the separation part 4 and the amount of CF₄ in the release gas is sufficiently small, release amount of CF₄ can be contained within the allowable release amount of CF₄ and the environmental load can be reduced.

As mentioned above, according to the atmospheric-pressure plasma processing apparatus 1, the desired recovery rate can be achieved and the desired collected CF₄ concentration can be achieved by automatically controlling the pressure control valves 52, 62 according to the flow rate of the processing gas. This allows the advantages of the atmospheric-pressure plasma processing over the vacuum plasma processing (reduction in cost, enhancement of processing capacity, etc.) to be fully exploited.

A total amount of CF₄ used can be reduced by the recovery, thereby surely reducing the running cost.

By making the processing gas CF₄ rich, even if some impure substance is mixed or even if the CF₄ concentration fluctuates to some degree, their impact on the processing can be prevented. Therefore, precise control of the flow rate of the processing gas is not required. Purification of the collected gas is not required, either. Therefore, a purifier device is not required, and equipment cost can be reduced. Reduction in the recovery rate of CF₄ by purification can also be avoided.

Other embodiments of the present invention will now be described. In the drawings, the same reference numerals will be used to designate the same elements as the aforementioned embodiment and the description thereof will be omitted.

While the collected gas pressure and the release gas pressure are controlled in the first embodiment, alternatively, the collected gas pressure and the exhaust gas pressure may be controlled.

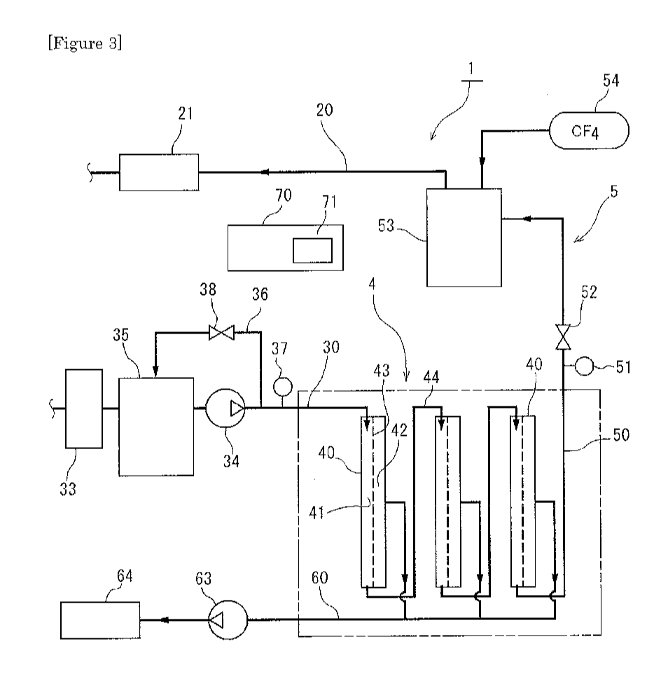

As shown in FIG. 3, in the second embodiment, the pressure sensor 61 and the pressure control valve 62 are not disposed in the release gas line 60. Instead, an exhaust gas buffer tank 35 is disposed between the ozone killer 33 and the compressor 34 of the exhaust gas line 30. The exhaust gas is pumped by the compressor 34 to the separation part 4 after being temporarily stored in the buffer tank 35.

A return passage 36 branches from the exhaust gas line 30 at a point more downstream than the compressor 34. The return passage 36 is connected to the exhaust gas buffer tank 35. A part of the exhaust gas pressure-fed by the compressor 34 is sent to the separation part 4 and the rest is returned to the buffer tank 35 by the return passage 36.

A pressure sensor 37 is disposed in the exhaust gas line 30 at a point more downstream than the branched portion of the return passage 36. Introduction pressure (exhaust gas physical quantity) of the exhaust gas introduced into the separation part 4 is detected by the pressure sensor 37. The pressure sensor 37 constitutes an exhaust gas physical quantity detector.

An exhaust gas pressure regulator 38 is disposed in the return passage 36. The exhaust gas pressure regulator 38, being an automatic pressure control valve, automatically controls the pressure of the return passage 36, thereby automatically controlling the introduction pressure of the exhaust gas introduced into the separation part 4.

Data as the relationship data regarding the set pressures of the collected gas and set pressures of the exhaust gas with respect to the flow rate of the processing gas are stored as the relationship data in the ROM 71 of the regulation controller 70. The regulation controller 70 operates the pressure control valves 52, 38 based on the flow rate of the processing gas at the mass flow controller 21, detected signals by the pressure sensors 51, 37 and the relationship data in the ROM 71, and feed-back controls the collected gas pressure and the exhaust gas pressure so that the collected gas pressure and the exhaust gas pressure respectively are the set pressures.

As with the first embodiment, this restrains the fluctuation of the recovery rate or the collected CF₄ concentration, thereby securing the stability of the processing.

The present invention is not limited to the embodiments described above, but various modifications can be made.

For example, flow velocity, flow rate or temperature of the gasses may be regulated, instead of the pressure, as the physical quantity related to the separation at the separation part 4.

The gases subject to the physical quantity regulation may be the exhaust gas and the release gas instead of the collected gas and the release gas (first embodiment) or the collected gas and the exhaust gas (second embodiment). A physical quantity of the three gases, i.e. the collected gas, the release gas and the exhaust gas may be regulated. A physical quantity of either one of the collected gas, the release gas or the exhaust gas may be regulated.

Relationship data in which the physical quantity continuously change according to the flow rate of the processing gas may be produced and stored in the data storage part 71 in the relationship obtaining step, and the physical quantity may be regulated based on the relationship data.

The physical quantity related to the separation may be regulated based on the flow rate of the exhaust gas instead of the flow rate of the processing gas.

The pressure of the connecting passages 44 between the separators 40 may be regulated according to the desired recovery rate or the concentration.

While the three separators 40 of the separation part 4 are connected in series in a three-step structure in the embodiments, the number of steps of the separator 40 may be changed according to the flow rate, the recovery rate or the recovery concentration, etc. of the exhaust gas or the collected gas. The separators 40 may be connected in parallel or may be connected in combination of series and parallel.

The substrate 9 may be fixed in position with the atmospheric-pressure plasma head 11 being moved with respect to the substrate 9.

A buffer tank for temporality storing the collected gas may be disposed at a portion of the recovered line 50 between the pressure regulator 52 and the mixing tank 53. A required amount of the collected gas may be sent from the buffer tank to the mixing tank 53 via a compressor.

Original features of the first embodiment and the second embodiment may be combined. For example, the buffer tank 35 and the return passage 36 may be disposed in the exhaust gas line 30 in the first embodiment in the same manner as in the second embodiment.

In the second embodiment, the pressure control valve 38 may be disposed in a portion of the exhaust gas line 30 more downstream than the pressure sensor 37 instead of the return passage 36. The buffer tank 35 and the return passage 36 may be omitted.

Application of the present invention is not limited to the etching of silicon, but may be applied to etching of other kinds of films such as oxide silicon and silicon nitride. The application of the present invention is not limited to the etching, but may be applied to other kinds of surface processing such as hydrophilization, hydrophobization and cleaning.

### EXAMPLE 1

Relationship of processing rate with respect to the flow rate of CF₄ and the added amount of H₂O was examined. CF₄ was diluted with Ar to make a total flow rate of CF₄ and Ar 1 slm and the flow rate of CF₄ was changed. H₂O was added to the mix gas of CF₄ and Ar and the gas was plasmatized under the atmospheric pressure. The added amount of H₂O was constant at 16 mg/min=8.89×10⁻⁴ mol/min. Since decomposition rate ε of CF₄ by the atmospheric pressure plasma is about ε=10%, stoichiometrically required amount of CF₄, in consideration of a decomposition rate, with respect to the added amount of H₂O mentioned above is 4.58×10⁻³ mol/min=0.103 slm.

In a separate step, O₂ was supplied to the ozonizer, and O₃ was produced. Supply flow rate of O₂ was 0.6 slm, about 8% of which was ozonized. The plasma gas made from the CF₄, Ar and H₂O and the gas containing ozone (O₂+O₃) from the ozonizer were blown out against a silicon film on a glass substrate to etch the silicon film. The substrate was conveyed (scanned) at a speed of 4 m/sec with respect to the plasma head.

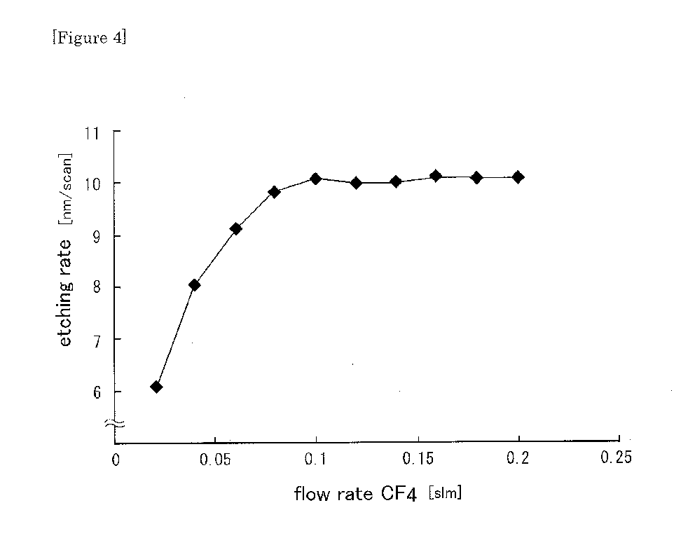

Then the etching rate of the silicon film per scan was measured. The result of the measurement is shown in FIG. 4.

The etching rate was increased as the flow rate of CF₄ was increased from the minimum rate. When the flow rate of CF₄ is 0.1 slm or higher, the etching rate was generally constant. Therefore, the required amount of the flow rate of CF₄ was consistent with the result of the calculation given above.

As shown above, the amount of CF₄ required for the etching rate to be constant can be obtained by calculation. It was confirmed that by making the flow rate of CF₄ greater than or equal to the required amount, i.e., by making the flow rate of CF₄ satisfy the expression 2 (more preferably the expression 3), the etching can be preformed securely even when the amount of CF₄ fluctuates to some degree and the etching rate can be controlled by adjusting the added amount of H₂O.

### INDUSTRIAL APPLICABILITY

The present invention can be applied to manufacturing of liquid crystal display apparatus and semiconductor apparatus.

### REFERENCE SIGNS LIST

1 atmospheric-pressure plasma processing system
2 atmospheric-pressure plasma processing part
4 separation part
5 recycling part
9 substrate
11 atmospheric-pressure plasma head
11a atmospheric-pressure discharge space
12 chamber
12a entrance port (opening)
12b exit port (opening)
13 conveyor (transporter and supporter for the substrates)
20 processing gas line
21 mass flow controller (flow rate controller)
22 inert gas supply line
23 water adding device
24 oxidizing gas supply line
25 ozonizer
30 exhaust gas line
31 scrubber
32 mist trap
33 ozone killer
34 compressor
35 exhaust gas buffer tank
36 return passage
37 exhaust gas pressure sensor (exhaust gas physical quantity detector)
38 pressure control valve (exhaust gas pressure regulator)
40 separator
41 first chamber
42 second chamber
43 separation membrane
44 connecting passage
50 collected gas line
51 collected gas pressure sensor (collected gas physical quantity detector)
52 pressure control valve (collected gas pressure regulator)
53 mixing tank
54 fluorine raw material replenishment part
60 release gas line
61 release gas pressure sensor (release gas physical quantity detector)
62 pressure control valve (release gas pressure regulator)
63 suction pump
64 detoxifier
70 regulation controller
71 relationship data storage part

1. A plasma processing method comprising:
a processing step of processing a surface of a substrate by plasmatizing a processing gas including a fluorine raw material under near atmospheric pressure and by bringing the processing gas into contact with the substrate;
a separating step of separating an exhaust gas generated in the processing step by a separation membrane into a collected gas in which the fluorine raw material is condensed to less than 100% and a release gas in which the fluorine raw material is diluted;
and a recycling step of utilizing the collected gas as at least a part of the processing gas;
wherein the separating step includes regulating a physical quantity of at least two gases of the collected gas, the release gas and the exhaust gas based on a flow rate of the processing gas so that either one or both of a rate (referred to as “recovery rate” hereinafter) of the fluorine raw material to be collected as the collected gas in the exhaust gas and a concentration (referred to as “recovery concentration” hereinafter) of the fluorine raw material in the collected gas are as desired, and wherein the physical quantity is related to the separation.

2. The plasma processing method according to claim 1 wherein the physical quantity is a gas pressure.

3. The plasma processing method according to claim 1 wherein one of the two gasses is the collected gas.

4. The plasma processing method according to claim 1 wherein the two gasses are the collected gas and the release gas.

5. The plasma processing method according to claim 1 wherein the method comprises a relationship obtaining step of obtaining relationship data regarding relationship between the flow rate of the processing gas and the physical quantity that allows either one or both of the recovery rate and the recovery concentration to be as desired, wherein the relationship obtaining step is performed prior to the processing step, and wherein the separating step includes regulating the physical quantity based on the relationship data.

6. The plasma processing method according to claim 1 wherein the method comprises a step of setting a desired value of the recovery rate so that an amount of the fluorine raw material in the release gas is less than or equal to an allowable release amount.

7. The plasma processing method according to claim 1 wherein the method comprises a step of setting a desired value of the recovery concentration so that a concentration of impure substance in the collected gas is less than or equal to an allowable amount of impure substance in the processing step.

8. The plasma processing method according to claim 1 wherein the method comprises a step of setting the desired value of the recovery concentration and setting the flow rate of the processing gas so that an amount of the fluorine raw material in the processing gas is not less than a stoichiometrically required amount thereof for generating reactive components of the surface processing, and wherein a decomposition rate at the time of the plasmatization is taken into account in the stoichiometrically required amount.

9. The plasma processing method according to claim 1 wherein the processing step includes adding water to the processing gas, hydrogen fluoride being generated as reactive components of the surface processing by plasmatization of the fluorine raw material and the water,
and wherein the method comprises a step of setting the desired value of the recovery concentration and setting the flow rate of the processing gas so that an amount of the fluorine raw material in the processing gas is excessive with respect to a stoichiometrically required amount thereof based on an added amount of the water for the generation of the hydrogen fluoride, and wherein a decomposition rate at the time of the plasmatization is taken into account in the stoichiometrically required amount.

10. The plasma processing method according to claim 1 wherein the recycling step includes replenishing the collected gas with a certain amount of the fluorine raw material.

11. A plasma processing apparatus comprising:
a processing part that performs a surface processing of a substrate by plasmatizing a processing gas including a fluorine raw material under near atmospheric pressure and by bringing the processing gas into contact with the substrate;
a separation part that separates an exhaust gas from the processing part by a separation membrane into a collected gas in which the fluorine raw material is condensed to less than 100% and a release gas in which the fluorine raw material is diluted;
a recycling part that utilizes the collected gas as at least a part of the processing gas;
a flow rate controller that controls a flow rate of the processing gas;
a regulator that regulates a physical quantity of at least two gases of the collected gas, the release gas and the exhaust gas, the physical quantity being related to the separation;
and a regulation controller for the regulator;
wherein the regulation controller includes a data storage part that stores relationship data regarding relationship between the flow rate of the processing gas and the physical quantity, wherein the relationship allows either one or both of a rate (referred to as “recovery rate” hereinafter) of the fluorine raw material to be collected as the collected gas in the exhaust gas and a concentration (referred to as “recovery concentration” hereinafter) of the fluorine raw material in the collected gas to be as desired, and wherein the regulation controller controls the regulator based on a controlled flow rate by the flow rate controller and the relationship data.

12. The plasma processing apparatus according to claim 11 wherein the regulator includes a gas pressure regulator that regulates pressure of the two gases.

13. The plasma processing apparatus according to claim 11 wherein the regulator includes a collected gas pressure regulator that regulates pressure of the collected gas and a release gas pressure regulator that regulates pressure of the release gas.

14. The plasma processing apparatus according to claim 11 wherein the relationship data are set so as to achieve a recovery rate at which the fluorine raw material in the release gas is less than or equal to an allowable release amount.

15. The plasma processing apparatus according to claim 11 wherein the relationship data are set so as to achieve a recovery concentration at which the concentration of impure substance in the collected gas is less than or equal to an allowable amount of impure substance in the processing part.

16. The plasma processing apparatus according to claim 11 wherein the controlled flow rate by the flow rate controller and the relationship data are set so that an amount of the fluorine raw material in the processing gas is not less than a stoichiometrically required amount thereof for generating reactive components of the surface processing, and wherein a decomposition rate at the time of the plasmatization is taken into account in the stoichiometrically required amount.

17. The plasma processing apparatus according to claim 11 wherein the apparatus further comprises an adding device that adds water to the processing gas, hydrogen fluoride being generated as reactive components of the surface processing by plasmatization of the fluorine raw material and the water;
wherein the controlled flow rate by the flow rate controller and the relationship data are set so that an amount of the fluorine raw material in the processing gas is excessive with respect to a stoichiometrically required amount thereof based on an added amount of the water for the generation of the hydrogen fluoride, and wherein a decomposition rate at the time of the plasmatization is taken into account in the stoichiometrically required amount.

18. The plasma processing apparatus according to claim 11 wherein a replenishment part that replenishes the collected gas with a certain amount of the fluorine raw material is connected to the recycling part.

19. The plasma processing apparatus according to claim 11 wherein the separation part comprises a plurality of steps of separators, each of the separators is partitioned by a separation membrane into a first chamber and a second chamber, the exhaust gas is introduced to the first chamber in the first step, the first chambers in the plurality of steps are connected in series, the collected gas is led out of the first chamber in the last step and the release gas is led out of the second chamber in each of the steps.

20. The plasma processing apparatus according to claim 11 wherein the processing part comprises a chamber having an opening always open to the atmospheric-pressure environment and the opening serves as an entrance port or an exit port for the substrate and the exhaust gas contains the processing gas after the processing and ambient gas sucked in from inside the chamber.
